(19) United States
(12) Patent Application Publication
(10) Pub. No.: US 2016/0266735 A1
(43) Pub. Date: Sep. 15, 2016

(54) DEFINING POSITION OF EMBEDDED CONTENT ON WEB PAGE

(71) Applicant: Antti TÖRRÖNEN, Ylojarvi (FI)

(72) Inventor: Antti TÖRRÖNEN, Ylojarvi (FI)

(21) Appl. No.: 15/066,562

(22) Filed: Mar. 10, 2016

(30) Foreign Application Priority Data
Mar. 13, 2015 (FI) 20155167

(51) Int. Cl. G06F 3/0481; H04L 29/08

(52) U.S. Cl. CPC G06F 3/0481; H04L 67/02

(57) ABSTRACT

There is provided methods and an apparatus for defining a position of embedded content on a web page. The web page is obtained from a first server entity and information for defining a position of the embedded content on the web page is obtained from a second server entity. The web page may be displayed, wherein the embedded content is positioned on the web page on the basis of the obtained information from the second server entity. A definition of the web page is generated on an administration user interface. The definition includes information defining a position of the embedded content on the web page. The generated definition of the web page is sent to the second server entity for maintaining information for defining the position of the embedded content on the web page in the second server entity.

### FIELD

The invention relates to web pages and embedded content on web pages.

### BACKGROUND

A typical web page includes Hypertext Markup Language (HTML) files(s) and possibly Cascading Style Sheets (CSS(s)), image file(s), script(s), Flash-files, audio files Java-applets and/or other resources. The HTML file describes content of the web page. The HTML file may include links to resource files, which may be stored on a single server or many different servers. The CSS file defines an outward appearance of the web page such as fonts and colors to be used on the web page.

A web browser is used to display web pages and to act as a user interface between a user and a web page. A script may be used by the web browser or a web server to shape the outward appearance of the web page or add interactivity on the web site. Shaping the web page on the server is performed for example in Progress WebSpeed, PHP by The PHP Group, and Microsoft Active Server Pages (ASP/ASP.net) environments.

A web widget may refer to an element of the web page. The web widget includes content that may be displayed on the web page by the browser as assisted by a browser plugin. The web widget may include various types of content to be displayed on the web page. The web widget may also provide functionalities to a user via the user interface of the web browser.

Locations of elements such as the web widget and other content on the web page are defined in the HTML file of the web page. This means that the locations of the elements may be only defined by the administrator of the web page. However, different web pages may be administered by different users and the elements displayed on the different web pages may vary significantly between the web pages. Some web pages may have many common elements but it is possible that there is only one common element or even no common elements. Moreover, outward appearances of the web pages may also vary significantly for example in terms of a number of columns the elements are arranged on the web page or used menu types. Accordingly, a definition of a location of an element on one web page may not necessarily be applicable to another web page.

Solutions for administration of web pages involve Content Management Systems (CMSs). In a CMS, a database is set up on a server that is used to populate a HTML template with the help of server-side development environments, such as PHP by The PHP Group, Microsoft Active Server Pages (ASP/ASP.NET), Java Server Pages by Sun Microsystems (JSP). Examples of CMS's include WordPress, Joomla, Drupal or domain-specific systems such as Moodie for learning and Magento or PrestaShop for e-commerce.

From the perspective of server administrator, usage of CMS's or custom server side code has several problems. For example, it requires installing a database server software, setting up the database, setting up the appropriate development environment specific to the operating system of the physical server. From the perspective of web designers, these systems require knowledge of the server development environment or the specific template model in CMS's. In addition, the restrictions of the CMS model might limit the possibilities in creation of layout and other design aspects. Finally, custom modifications to CMS's or proprietary software running on server side development environments require extensive testing.

Frequently, server-side code is run synchronously, i.e. instructions are not computed in parallel. In addition, server-side output, such as HTML, is transferred to the client as a single transaction, or a series of transactions. Preferably, the web site would consist of parts that could be downloaded to the client in parallel to take full advantage of fast broadband networks. Preferably, the web site would consist of code that can be run on the server in parallel, i.e. asynchronously, to take advantage of modern multi-core server systems.

### BRIEF DESCRIPTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

According to an aspect, there is provided the subject matter of the independent claims. Embodiments are defined in the dependent claims.

One or more examples of implementations are set forth in more detail in the accompanying drawings and the description below. Other features will be apparent from the description and drawings, and from the claims.

Some embodiments provide control of the position of embedded content on a web page by a separate server from the server hosting the web page. In this way administration of web pages is simplified without significantly increasing requirements for processing power and execution environment of web servers.

### BRIEF DESCRIPTION OF THE DRAWINGS

In the following the invention will be described in greater detail by means of preferred embodiments with reference to the attached drawings, in which

FIG. 1 illustrates an example of a communications system according to an embodiment;

FIGS. 2a and 2b illustrate examples of communications between entities in a system according to an embodiment;

FIG. 3 illustrates an example of administration of a web page according to an embodiment; and

FIG. 4 illustrates an example of an apparatus according to an embodiment.

### DETAILED DESCRIPTION OF THE INVENTION

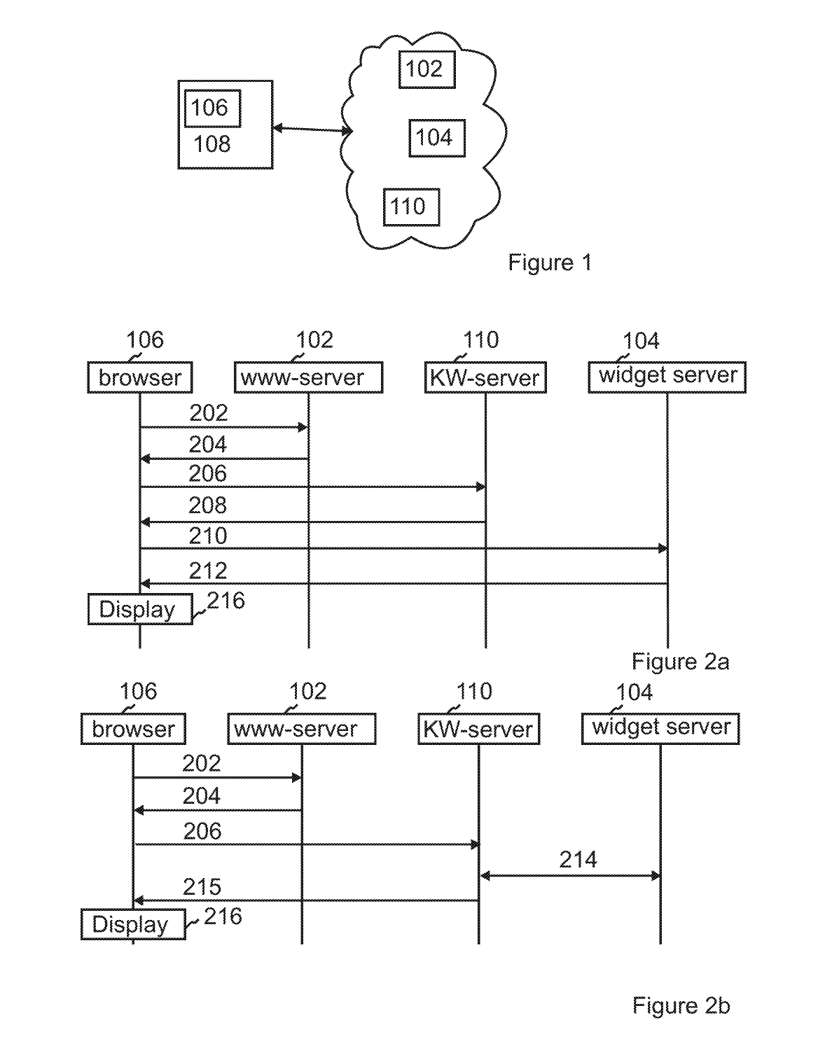

FIG. 1 illustrates an example of a system according to an embodiment. The system comprises a client entity 108 that may be connected to one or more server entities 102, 104, 110 for obtaining information and/or services from the server entities. The client entity may be a web browser 106 capable of displaying, retrieving and traversing web pages. Accordingly, the web browser acts as a user interface of the web pages. At least one of the server entities 102, 104, 110 may act as a web server (WWW-server) such that it hosts at least one web page and sends the web page in response to a request including an identifier of the web page. At least one of the server entities 102, 104, 110 may act as a position configurator (KW-server) for defining a position of the embedded content on the web page. At least one of the server entities 102, 104, 110 may act as a content server (widget server). The content server hosts content such that the content may be retrieved by the client entity for displaying the content as embedded content on the web page.

The client and server entities may be connected by a wireless or wired connection. Examples of the wired connections comprise for example an Ethernet connection. Examples of the wireless connection comprise cellular communications network connections and Institute of Electrical and Electronics Engineers' IEEE 802.11 based wireless local area network connections. The client and server entities may communicate using a request response protocol. The client entity may send a request for the web page for obtaining the web page from the server entity. The request may identify the web page such that the server entity may send a response to the request, wherein the response may include the identified web page in the request. A request-response protocol, for example a Hyper Text Transfer Protocol (HTTP) defined by the Internet Engineering Task Force (IETF) standards, may be used by the client entity and the server entities for communications of information, for example web pages, information for defining position of embedded content and/or content.

FIGS. 2a and 2b illustrate examples of communications between entities in a system according to an embodiment. The entities perform methods according to embodiments. The entities may be the client and server entities described in the system of FIG. 1. The communications in FIGS. 2a and 2b are now described with reference to the entities of FIG. 1.

A client entity 106 may obtain a web page 204 from a server entity 102 acting as a web server. The web page may be obtained in response to a request 202 for the web page from the client entity to the server entity acting as a web server. The obtained web page may include a reference to a server entity 110 acting as a position configurator for defining a position of embedded content on the web page. The web page may include a reference to the embedded content. On the other hand the reference to the embedded may be obtained from the server entity acting as a position configurator. The references to the server entity acting as a position configurator and to the embedded content may be links, for example HTTP links. A link to the server entity acting as a position configurator may identify the server. A link to the embedded content may identify the content.

The embedded content may comprise for example a script, an image, Java applet, a video, an audio, text, a form, an animation, a 3D model, an image sequence, a game or a client-side web widget. The animation may be provided using HTML 5, animated images or Adobe Flash platform, for example. The image sequence might comprise an animation, 180 degree view or 360 degree view, or a sequence of banner images, for example. The embedded content may be stored in a file readable by applicable software executed on a computer. The embedded content may be content that is associated, for example by a reference, to the web page 204. In this way the embedded content may be retrieved for displaying on the web page. Accordingly, the file storing the content and the definition web page are separate files of different types. Preferably the content file and the definition of the web page may be stored on different server entities.

The definition of the web page may be a single HTML file, a group of HTML files, a Document Object Model DOM representation of the web page or a data structure representing elements to be inserted, positioned, deleted or modified on an administered web page. Optionally, other markup language maybe used for the definition of the web page, such as Extensible Markup Language XML, Wireless Markup Language WML, or Extensible Application Markup Language XAML. A HTML file of the web page may define elements, for example <script>, <iframe> and <image> that include the reference to the embedded content and indicate the content type. The script file may be a shell script or according to a scripting language, for example Python, Javascript, VBScript or any ECMAScript compliant language. The link may identify the server entity and the content. An example of the link may be:

<script src=“http://www.content.com/contentfile.js”></script>,

wherein the server entity is identified by the “www.content.com” and the content may be identified by a filename “content_file.js” of the content. Accordingly, in this example the content is a Javascript file indicated by the <script> element.

In an embodiment, the embedded content may comprise a Client-Side Web Widget (CSWW) for displaying third party content including various types of content, for example a script, an image, Java applet, a video, an audio, text, a form, an animation, a 3D model, an image sequence, a game or a client-side web widget. The animation may be provided using HTML 5, animated images or Adobe Flash platform, for example. The CSWW may include a reference to the third party content that is retrievable from a server entity acting as a content server. The reference may be for example a HTTP link. Accordingly, in the CSWW, the content is located in the server entity acting as a content server, where the content may be retrieved for displaying on the web page.

The web page may include a reference to the CSWW, whereby the web browser may retrieve and possibly execute the CSWW from a content server. The CSWW may be displayed on the web page by the browser as assisted by a browser plugin. The web browser may acts as a host application to the plugin that can only be executed together with the web browser. The web browser on the other hand may be executed independently from the plugin.

Since the server entities hosting the web page and the CSWW are different the CSWW may be referred to as a 3^{rd} party CSWW. The CSWW may provide functionalities to a user via the user interface of the web browser. The functionalities may allow user interaction with the CSWW and the displayed content. The CSWW also may communicate with a script or a database on the server entity hosting the CSWW. In this way the outward appearance of the CSWW may be controlled by the script. Input from the user via the user interface may be communicated to the script and used in controlling the outward appearance of the CSWW. Since the CSWW is hosted by a different server entity than the web page, web pages that include CSWWs facilitate adding content to the web pages without significantly increasing requirements for processing power and execution environment of the web server. Moreover, the same client-side web widget may be utilized in many web pages, which improves efficiency of software development and testing.

The client entity 106 may send a request 206 including information for identifying the web page to the server entity 110 acting as a position configurator. The information for identifying the web page to the server entity may comprise a Uniform Resource Locator (URL), or more generally a Uniform Resource Identifier (URI) including the name of the web page. Information identifying the page may be submitted as part of the HTTP request 206 in any HTTP header, such as HTTP Referrer, or as part of the requested reference URL, such as part of the filename or query string, or by other means. The request may be sent after the web page 204 has been obtained.

The server entity acting as a position configurator may maintain information, for example URLs, for identifying at least one web page retrievable from a server entity acting as a web server, maintain information for defining a position of the embedded content on the web page, and send, in response to a request including information for identifying the web page, a response 215 including information for the web page identified by the request, said information for the web page comprising information for defining a position of the embedded content on the web page. The information for defining a position of the embedded content on the web page may comprise a defined position of embedded content, whose execution may cause defining the position of the embedded content and/or adding the embedded content to the defined position on the web page. The information identifying the web page included in the request 206 may be matched against the information identifying web pages maintained in the server entity acting as a position configurator for finding the information for defining a position of the embedded content maintained in the server entity. In the server entity acting as a position configurator, the information for defining the position may be stored in association with the information identifying the web page for displaying the embedded content. In one example the information for defining the position and the information identifying the web page may be stored to a database, where they are linked to each other for example by table keys.

The client entity may obtain the information 208 for defining a position of the embedded content on the web page from the server entity acting as a position configurator in response to the request 206. In this way position of embedded content on the web page may be controlled by a separate server entity from the server entity hosting the web page. The information for defining a position of the embedded content may comprise a defined position of the embedded content, whose execution may cause defining the position of the embedded content and/or adding the embedded content to the defined position on the web page. In one example, the information for defining a position of the embedded content may be a script. The defined position may be a position of the embedded content in a Document Object Model DOM of the web page.

A DOM comprises tags that each forms an object in the DOM. An object in the DOM may include one or more child objects. Accordingly, the objects in the DOM may form a tree-like data structure, i.e. a DOM element tree. Embedded content may be added to a defined position on the web page by forming an object representing the embedded content to the defined position in the DOM of the web page. The object representing the embedded content may be a root object in the DOM, a child object in the DOM or a parent object in the DOM. The root object may include only references to child one or more child objects. A parent object may be a root object. A child object may be a child object of a parent object. A child object may be a parent object of another child object. The objects may include references to their parent objects, child objects and/or root objects. The web page may be displayed 216 such that the embedded content is positioned on the web page on the basis of the obtained information 208 from the server entity acting as a position configurator. The obtained information 208 from the server entity acting as a position configurator may be used to generate the web page, where the embedded content is added to a defined position. The position of the embedded on the web page may be defined by the information 208 obtained from the server entity acting as a position configurator. The position of the embedded content may be defined as a position in a DOM element tree of the web page. Accordingly, the position of the embedded content may be defined relative to other objects of the DOM. Examples of the other objects include other embedded content.

Further examples of the position of the embedded content comprise a pixel distance from any element of the web page or screen borders, relative to any element, which could be defined, for example, by id attribute or any other HTML tag attribute, visible content or a hash calculation of the content.

In an embodiment illustrated in FIG. 2a, embedded content to be displayed 216 on the web page may be obtained from a server entity 104 acting as a content server. The embedded content 212 may be obtained in response to a request 210 from the client entity. The request may be generated on the basis of the obtained information 208 from the server entity acting as a position configurator. The information from the server entity acting as a position configurator may include a reference to the content on the server entity acting as a content server. The reference may be included in a script 208 including information for defining a position of the embedded content.

In an embodiment illustrated in FIG. 2b, embedded content to be displayed 216 on the web page may be obtained from the server entity 110 acting as a position configurator. In this way the embedded content and the position of the embedded content on the web page may be delivered to the client entity from the same server entity. Preferably the server entity acting as a position configurator may deliver in a single file to the client entity. The single file may include both the embedded content and information for defining the position of the embedded content on the web page. The information for defining the position may include a script whose execution may cause that the embedded content may be added to the defined position on the web page. The execution of the script may cause finding the defined position on the web page and adding the embedded content on the web page.

It should be appreciated that in the embodiments illustrated in FIGS. 2a and 2b, after the request 206, 215, information defining the position or information for defining the position is delivered to the client entity. The information defining the position may be, for example, a location in a DOM element tree, pixel distance from any element or screen borders, relative to any element, which could be defined, for example, by id attribute or any other HTML tag attribute, visible content or a hash calculation of the content.

The embedded content may be stored to the server entity 110 acting as a position configurator such that the embedded content may be delivered 215 to the client entity together with the information for defining a position of the embedded content. An example of delivering the information for defining a position of the embedded content may be as described in item 208. On the other hand the server entity 110 acting as a position configurator may retrieve 214 the embedded from a server entity 104 acting as a content server for delivery to the client entity.

In some occasions, the request 206 may fail to deliver adequate information identifying the web page, for example, due to browser or firewall restrictions on the client entity or network. In addition, bots and search engine spider may or may not send this information as part of 206. In this case, the server entity 110 may respond to the request 206 by sending a script for the purpose of fetching the information identifying the web page, such as the name of the web page or URI, and transmitting this information to the server entity 110. Optionally, any data available from the client entity, such as a HTTP POST fields or any part of the URL, such as Query String or Anchor text link, may be used for identifying the web page. The contents or meta data of the web page or part thereof may also be used for identifying the page. An example of the Query String is a string of characters following an address of the web page. The Query String may include one or more pairs of “?” and “name=value” items. The Anchor Text Link may be a position on the web page identified by “#”-character. In principle the web page may be identified on the basis of the content of the web page, for example on the basis of the combination of the title displayed on the web page and other information on the web page. The content-based identification may be preferred, when the content of the web page is changed without a change of the URL address of the web page, which could follow, when the content is Flash or JavaScript.

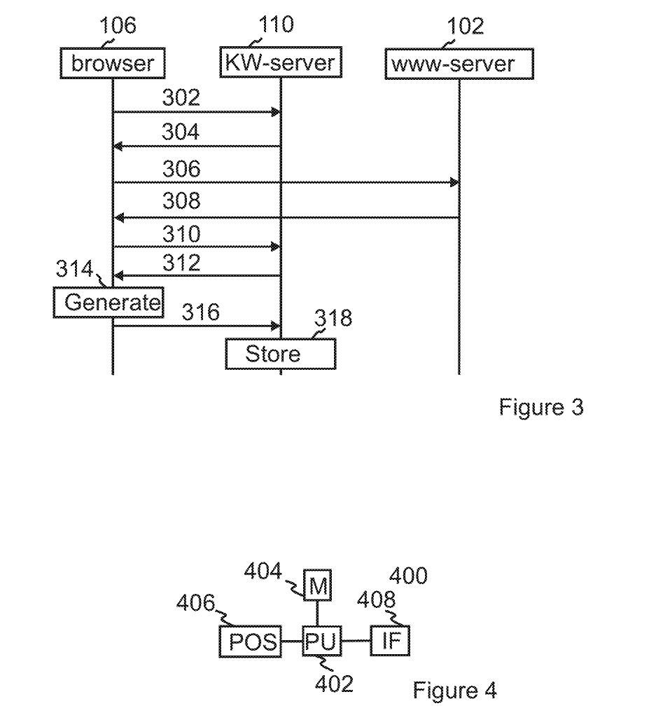

FIG. 3 illustrates an example of administration of a web page according to an embodiment. The administration of the web page may comprise configuring content on the web page. The configuring may comprise adding content, for example embedded content, on the web page and positioning the content to the web page. The entities in FIG. 3 may be the client and server entities in the system of FIG. 1. The client and server entities may perform methods according to embodiments. The administration may be performed by a user operating a client entity. The client entity may comprise a user interface for allowing a user to enter commands and to obtain visual information. The client entity may be a computer, a web browser executed in the computer, or other device such as a smartphone or tablet. The device may include input means for the user to enter commands and information, and output means for the user to obtain information. Examples of the input means may comprise various computer peripherals such as a mouse, keyboard and a touch pad. Examples of the output means may comprise a display and a speaker. A touch screen may be used to provide both input and output interface to the user in a single device.

The browser may obtain a web page 308 from a server entity acting as a web server. The web page may be obtained for administration of the web page by the user. The web page may include a reference to a server entity acting as a position configurator for defining a position of embedded content on the web page. The reference may be a link to content, for example a script, on the server entity acting as a position configurator. The web page may be obtained in response to a request 306 for the web page.

The browser may send a request 310 including information for identifying the web page to the server entity acting as a position configurator. The request may comprise the reference to the server entity obtained in the web page. The information for identifying the web page may comprise a reference to the web page. The reference may be a link for identifying and retrieving the web page from the server entity acting as a web server. The request may include a cookie for identifying that the browser is authorized for administration of the web page. The authorization of the browser may be provided by credentials of the user operating the browser. Accordingly, the server entity acting as a position configurator may identify that the user is authorized on the basis of the cookie in the request. Optionally, other means, such as client certificates or fingerprint technology may be used for authorization.

When the user is authorized, the browser may obtain from the server entity acting as a position configurator information 312 for defining a position of the embedded content on the web page and information 312 for generating 314 an administration user interface for the web page. The administration user interface for the web page may be generated on top of the web page to be administered.

The obtained information may include a definition of the administration user interface. The definition may be an administration web page that may include one or more scripts, images and HTML files and optionally other files. The information for generating an administration user interface may comprise a script, whose execution causes adding a menu, buttons and possible other content to the administration web page.

The administration user interface may allow defining a position of the embedded content on the web page for administration of the web page. The administration user interface may be generated 314 on the basis of the obtained information 312, and displayed on the web browser. The administration user interface may include administration tools and a view of the web page obtained for administration.

A definition of the administered web page may be generated 314 on the administration user interface, said definition including information defining a position of the embedded content on the web page. The definition of the administered web page may be a single HTML file, a group of HTML files or a DOM representation of the web page or a data structure representing the elements to be inserted, positioned, deleted or modified on the web page to be administered. In the definition of the administered web page, the embedded content may be in the defined position. The position may be defined by the user via the administration user interface. The administration user interface may be operated by the user via the input and output means of the client entity. The position may be defined on the basis of the user selecting one or more items and/or entering information to the administration user interface.

In one example, the definition of the administered web page may be generated 314 by a “drag and drop”-functionality provided on the administration user interface. In the “drag and drop”-functionality the embedded content may be selected and moved to a position on the web page. The embedded content may be added to the position, when the embedded content is released by the “drag and drop”-functionality. The release of the embedded content may cause execution of a script, for example JavaScript that may generate a definition of the administered web page, where the embedded content is defined to the position, where the embedded content is released by the “drag and drop”-functionality. The position may be defined as pixels and/or as object relationship in a DOM of the web page. The “drag and drop”-functionality is conventionally provided in most present operating systems for example in the Microsoft Windows.

At least a portion of the generated 314 definition of the web page 316 may be sent to the server entity acting as a position configurator, where the definition may be stored 318 for maintaining information for defining a position of the embedded content on the web page in the server entity acting as a position configurator. The portion of the generated definition of the web page may include one or more elements or information identifying the embedded content or other elements, whose position has been defined by the user via the administration user interface. It should be appreciated that also the whole generated definition of the web page may be sent instead of the portion.

In an embodiment, the generated 314 definition of the web page 316 may comprise information required for creation of information 208 in a structure format, such as a JSON or CSV string, binary format or any other structured format, including information about absolute and relative position for each inserted or modified element, for example, this ID of parent, sibling or other HTML elements and their position in the DOM hierarchy of the web page, or pixel dimensions from screen borders or other elements or any other information defining the position in the DOM tree or HTML code or other representation model of the web page.

In another embodiment the server entity acting as a positioning configurator may process the generated 314 definition of the web page 316 for maintaining the information in a suitable format for creation of the information 208 for defining a position of the embedded content in relative or absolute terms, such as processing attributes of parent and sibling HTML elements, the contents thereof, pixel dimensions from screen borders or other elements or the contents of elements before or after or any other information defining the position in the DOM tree of web page, for example. In this embodiment the generated 314 web page 316 may comprise parts or full HTML markup of the web page to be administrated.

In another embodiment, the generated 314 definition of the web page may be a script that is generated by the client entity, for example by means of capturing and serializing program commands used for updating the administration user interface based on the action of the user.

In all embodiments the storing 318 may also comprise the original HTML markup of the web page to be administered fully or partly for further analysis, and recreation of the information 208 for defining a position in the web page.

In one example, a definition of the administered web page may be generated 314, when the user adds embedded content or other elements to defined positions on the administered web page. Using the “drag and drop”-functionality a defined position may be the position, where the element is released. At least a portion of the generated definition may be sent to the server entity acting as a position configurator, where the definition 318 of the web page may be stored. The generated definition may be a structure comprising one or more elements, for example embedded content, added to the web page, and positions of the added elements on the web page.

An example of the generated definition may be for example:

```
ConfigurationItem
{
  Method=”Insert” ,
  ItemType=”TextBox” ,
  ParentItem= { id=”areaname”, contentlength=255, conten-
```

thash=”AC2355CE22333”} ,

```
  ItemIndexInParent=2,
  SiblingsBefore= { { id=null, contentlength=2, conten-
```

thash=”435345CE22333” } } ,

```
  SiblingsAfter=null,
  PixelsFromTop=344,
  PixelsFromLeft=11
}
```

Another example of the generated definition may be the HTML code or DOM structure of the web page to be administered created by the administration user interface.

The server entity acting as a position configurator may create information, for example script, for defining a position of the embedded content according to the generated definition. This information may be sent to a client entity for example in the responses in items 208 and 215 in FIGS. 2a and 2b. The script may be created in connection with storing 318 the portion of the definition of the web page. On the other hand the script may be generated following a request, for example the requests in items 206 and in FIGS. 2a and 2b. The script may be generated after every request or separately for every request.

In this way position of embedded content on the web page may be controlled by a separate server from the server hosting the web page. Accordingly, the information defining the position of the embedded content included in the definition may be retrieved from the server entity acting as a position configurator for positioning the embedded content on the web page. FIGS. 2a and 2b illustrate examples of the requests 206 that may cause that information 208, 215 for defining a position of the embedded content on the web page may be sent by the server entity acting as a position configurator.

In an embodiment, an administration interface of the web page is provided in response to a request 310 from an authorized user, and the administration interface includes an element for configuring a position of the embedded content on the web page. The element may be an element of the web page defining the administration interface, such as an image, a form element, an icon or other placeholder, any HTML element or a group of any elements. The user may be authorized to the server entity acting as a position configurator by an authorization process including the user, the browser and the server entity acting as a position configurator. The authorization process may include a request 302 and a response 304. The request may include user credentials of the user, for example a username and a password, or a client certificate. The request 302 may preferably include information for identifying a specific web page for which authorization is requested for administration of the web page. In this way the user may be authorized to administer only a specific web page or a group of web pages, and another user may be authorized to administer other web pages or other group of web pages.

The request 302 may be sent to the server entity acting as a position configurator. The server entity receiving the authorization request may authorize the user on the basis of the information included in the request and send an authorization response 304 that may indicate a successful or an unsuccessful authorization. The response 304 may include a cookie that may indicate a successful authorization of the user. Preferably the browser may be restricted to send the cookie to other servers than the server entity acting as a position configurator. The restriction may be implemented for example by the Same origin policy principle in JavaScript. In the Same origin policy, the browser should only send a cookie to the domain that originally set the cookie.

FIG. 4 illustrates an example of an apparatus 400 according to an embodiment. The apparatus comprises at least one processor 402 and at least one memory 404 for storing instructions to be executed by the processor. The at least one memory and the instructions are configured to, with the at least one processor, cause the apparatus at least to perform a method according to an embodiment. The apparatus may be a client entity or a server entity described in the above embodiments, for example in FIG. 1. The instructions may comprise program code for execution on the processor. The program code may be a computer program code.

In an embodiment the apparatus may comprise a positioning unit 406 for performing functionalities of an embodiment. The functionalities may comprise generating a definition of the web page, said definition including information defining a position of the embedded content on the web page. Alternatively or additionally the functionalities may comprise displaying a web page, wherein the embedded content is positioned on the web page on the basis of information obtained from a server entity acting as a position configurator. Alternatively or additionally the functionalities may comprise maintaining information for defining a position of the embedded content on a specific web page.

In an embodiment the apparatus may comprise an interface 408 for communicating information between a client and server entities and/or for communicating information between a client entity and a user. The apparatus may comprise a display for displaying at least one of the embedded content and the web page. The information communicated between the client and server entities may comprise at least information for defining a position of the embedded content on the web page.

Entities of the apparatus according to an embodiment may be electrically connected for communications of information, data and/or messages. The connections may be provided by wires, circuit boards and/or computer buses depending on implementation of the apparatus.

In one example, the client entity and the server entities may be computers connected by a communications network, for example the Internet. On the other hand the client entity, for example a web browser, and the server entities, may be computer programs or computer program codes, for example scripts, that are executed in an apparatus according to an embodiment. The apparatus according to an embodiment may include at least one processor and at least one memory that form a processing unit for execution of computer programs.

In an embodiment there is provided a computer program comprising computer program code for execution on a computer to cause a method according to an embodiment. The computer program may be embodied on a computer-readable storage medium.

In an embodiment there is provided a computer program product for a computer, comprising a computer program according to an embodiment.

In an embodiment, an apparatus, for example a client entity or a server entity described in an embodiment, may comprise at least one processor, memory and a computer program code that form processing means for carrying out an embodiment.

Embodiments as described may also be carried out in the form of a computer process defined by a computer program. The computer program may be in source code form, object code form, or in some intermediate form, and it may be stored in some sort of carrier, which may be any entity or device capable of carrying the program. For example, the computer program may be stored on a computer-readable storage medium. The computer-readable storage medium may be a computer program distribution medium readable by a computer or a processor. The computer-readable storage medium may be, for example but not limited to, a record medium, computer memory, read-only memory, electrical carrier signal, telecommunications signal, and software distribution package, for example.

The techniques described herein may be implemented by various means so that an apparatus implementing one or more functions of a positioning unit, a web browser, a client entity or a server entity described with an embodiment comprises not only prior art means, but also means for implementing the one or more functions of a corresponding apparatus described with an embodiment and it may comprise separate means for each separate function, or means may be configured to perform two or more functions. For example, these techniques may be implemented in hardware (one or more apparatuses), firmware (one or more apparatuses), software (one or more modules), or combinations thereof. Information, for example data, messages, content, embedded content, web page and definition of the web page may be stored a file readable by applicable software executed on a computer. In one example implementation, a positioning unit, a web browser, client entity or a server entity may be software application that is executable in a platform. The platform may be a software and/or hardware platform capable of executing the web browser. A computer may be an example of a hardware platform. A software platform may comprise, for example an operating system. A combination of hardware and software platform may be formed by an operating system that is executable on a computer. Examples of the software platforms include operating systems, for example IOS and OSX from Apple Inc., and Windows Vista and Windows Phone from Microsoft and Android from Google. Examples of the web browsers include Mozilla Firefox, Opera, Google Chrome and Windows Internet Explorer. Web browsing functionality may also be implemented inside another software program, for example, by the use of Apache Cordova or Adobe PhoneGap for mobile devices.

For a firmware or software, implementation can be through modules (e.g., procedures, functions, and so on) that perform the functions described herein. The computer program codes may be stored in any suitable, processor/computer-readable data storage medium(s) or memory unit(s) or article(s) of manufacture and executed by one or more processors/computers. The data storage medium or the memory unit may be implemented within the processor/computer or external to the processor/computer, in which case it can be communicatively coupled to the processor/computer via various means as is known in the art.

According to an embodiment, the apparatus such as a client entity or a server entity may comprise processing means configured to carry out any of the embodiments of FIGS. 2a, 2b and 3.

A skilled person may acknowledge advantages provided by the above described features and embodiments and may combine them in order to implement a client entity or a server entity according to the invention.

It will be obvious to a person skilled in the art that, as the technology advances, the inventive concept can be implemented in various ways. The invention and its embodiments are not limited to the examples described above but may vary within the scope of the claims.

1. A method comprising:
obtaining a web page from a first server entity, said web page including a reference to a second server entity for defining a position of embedded content on the web page;
sending a request including information for identifying the web page to the second server entity;
obtaining from the second server entity, in response to the request, information for defining a position of the embedded content on the web page; and
displaying the web page, wherein the embedded content is positioned on the web page on the basis of the obtained information from the second server entity.

2. A method comprising:
obtaining a web page from a first server entity, said web page including a reference to a second server entity for defining a position of embedded content on the web page;
sending a request including information for identifying the web page to the second server entity;
obtaining from the second server entity information for generating an administration user interface for the web page;
generating a definition of the web page on the administration user interface, said definition including information defining a position of the embedded content on the web page; and
sending at least a portion of the generated definition of the web page to the second server entity for maintaining information for defining the position of the embedded content on the web page in the second server entity.

3. A method comprising:
maintaining information identifying at least one web page retrievable from a first server entity and said web page including a reference to a second server entity for defining a position of embedded content on the web page;
maintaining information for defining a position of the embedded content on the at least one identified web page; and
sending, in response to a request including information for identifying the web page, a response including information for the web page identified by the request, said information for the web page containing information for defining a position of the embedded content on the web page.

4. A method according to claim 1, comprising:
generating by the second server entity, a web page, wherein the web page contains the embedded content in a position defined by the information for defining a position of the embedded content.

5. A method according to claim 1, wherein the information for defining a position of the embedded content contains a position of the embedded content in a Document Object Model DOM of the web page.

6. A method according to claim 1, wherein an administration interface of the web page is provided in response to a request from an authorized user, and the administration interface includes an element for configuring a position of the embedded content on the web page.

7. A method according to claim 1, wherein the embedded content contains a script, an image, Java applet, a video, an audio, text, a form, an animation, a 3D model, an image sequence, a game or a client-side web widget.

8. An apparatus, comprising:
at least one processor, and
at least one memory for storing instructions to be executed by the processor, wherein
the at least one memory and the instructions are configured to, with the at least one processor, cause the apparatus at least to perform:
obtaining a web page from a first server entity, said web page including a reference to a second server entity for defining a position of embedded content on the web page;
sending a request including information for identifying the web page to the second server entity;
obtaining from the second server entity, in response to the request, information for defining a position of the embedded content on the web page; and
displaying the web page, wherein the embedded content is positioned on the web page on the basis of the obtained information from the second server entity.

9. An apparatus, comprising:
at least one processor, and
at least one memory for storing instructions to be executed by the processor, wherein
the at least one memory and the instructions are configured to, with the at least one processor, cause the apparatus at least to perform:
obtaining a web page from a first server entity, said web page including a reference to a second server entity for defining a position of embedded content on the web page;
sending a request including information for identifying the web page to the second server entity;
obtaining from the second server entity information for generating an administration user interface for the web page;
generating a definition of the web page on the administration user interface, said definition including information defining a position of the embedded content on the web page; and
sending at least a portion of the generated definition of the web page to the second server entity for maintaining information for defining the position of the embedded content on the web page in the second server entity.

10. An apparatus, comprising:
at least one processor, and
at least one memory for storing instructions to be executed by the processor, wherein the at least one memory and the instructions are configured to, with the at least one processor, cause the apparatus at least to perform:
maintaining information identifying at least one web page retrievable from a first server entity and said web page including a reference to a second server entity for defining a position of embedded content on the web page;
maintaining information for defining a position of the embedded content on the at least one identified web page; and
sending, in response to a request including information for identifying the web page, a response including information for the web page identified by the request, said information for the web page containing information for defining a position of the embedded content on the web page.

11. An apparatus according to claim 8, wherein the apparatus comprises:
a display for displaying at least one of the embedded content and the web page.

12. An apparatus according to claim 8, wherein the apparatus comprises:
an interface for communicating information for defining a position of the embedded content on the web page.

13. An apparatus according to claim 9, wherein the apparatus comprises:
a display for displaying at least one of the embedded content and the web page.

14. An apparatus according to claim 10, wherein the apparatus comprises:
a display for displaying at least one of the embedded content and the web page.

15. An apparatus according to claim 9, wherein the apparatus comprises:
an interface for communicating information for defining a position of the embedded content on the web page.

16. An apparatus according to claim 10, wherein the apparatus comprises:
an interface for communicating information for defining a position of the embedded content on the web page.

17. A method according to claim 2, comprising:
generating by the second server entity, a web page, wherein the web page contains the embedded content in a position defined by the information for defining a position of the embedded content.

18. A method according to claim 3, comprising:
generating by the second server entity, a web page, wherein the web page contains the embedded content in a position defined by the information for defining a position of the embedded content.

19. A method according to claim 2, wherein the information for defining a position of the embedded content contains a position of the embedded content in a Document Object Model DOM of the web page.

20. A method according to claim 3, wherein the information for defining a position of the embedded content contains a position of the embedded content in a Document Object Model DOM of the web page.
